(19) United States
(12) Patent Application Publication
(10) Pub. No.: US 2016/0148547 A1
(43) Pub. Date: May 26, 2016

(54) MULTIUSE MARKETING DISPLAY DEVICE

(71) Applicant: Jose Rivera, Akron, OH (US)

(72) Inventor: Jose Rivera, Akron, OH (US)

(21) Appl. No.: 14/551,182

(22) Filed: Nov. 24, 2014

(51) Int. Cl. G09F 19/00; B67B 7/16; A45C 1/12

(52) U.S. Cl. CPC G09F 19/00; A45C 1/12; B67B 7/16

(57) ABSTRACT

A marketing display device may comprise a simulated helmet or hat that is compressed in the lateral direction. The device may be stabilized against tip-over by having a thickness-to-height ratio that decreases from the crest to the base yielding low center of gravity. The device may include one or more display surfaces for displaying, e.g. advertising information, graphics, or other printed matter.

### I. BACKGROUND OF THE INVENTION

A. Field of Invention

Embodiments of the invention generally relate to devices and methods for displaying advertising and marketing materials.

B. Description of the Related Art

Certain stylized forms of simulated football helmets are known in the art, as are devices for holding or displaying printed matter. However, known simulated helmets tend to either be realistic in their dimensions which provides an excessively large footprint, or they are very narrow and thus top-heavy objects which are prone to tipping over. What is needed is a device which is more stable and less prone to tip over, but also has a small footprint.

Some embodiments of the present invention may provide one or more benefits or advantages over the prior art.

### II. SUMMARY OF THE INVENTION

Some embodiments may relate to a marketing display device, comprising a simulated football helmet comprising a left side and a right side, wherein a distance from the left side to the right side defines a thickness, and wherein the simulated football helmet comprises a crest and a base wherein a distance from the crest to the base defines a height; a thickness-to-height ratio that decreases from the crest to the base yielding a center of gravity of the device is located at a point greater than half of the distance from a highest point of the crest to a lowest point of the base; one or more display surfaces for displaying advertising information and/or graphics, the one or more display surfaces being disposed on one or more of the left side or the right side; and the base of the device comprising a stand adapted to stabilize the device in an upright orientation on an arbitrary flat surface.

According to some embodiments the crest extends from a fore region of the device to an aft region of the device along a generally curved path tracing out a portion of a profile of the simulated football helmet.

According to some embodiments the crest extends in a lateral direction from the left side of the device to the right side of the device tracing out a generally flat path from the left side to the right side.

According to some embodiments the thickness-to-height ratio decreases from between 0.2 and 0.3 inclusive at the crest to between 0.4 and 0.5 inclusive at the base.

According to some embodiments the crest defines a display surface.

Some embodiments may include a vessel disposed in the space between the left side, the right side, and the crest, the device being adapted to retain the vessel therein.

Some embodiments may include a port in fluid communication with an interior of the vessel.

Some embodiments may include structure for sealing the port, the structure being selected from one or more of a cap, a hand pump, or a bung.

According to some embodiments the port defines a slot adapted to receive coins.

Some embodiments may include a simulated facemask.

According to some embodiments the one or more display surfaces comprise a material selected from an adhesive release material, a dry erase substrate, a chalk slate, or a static decal substrate.

Embodiments may relate to a marketing display device, comprising a simulated football helmet comprising a left side and a right side, wherein a distance from the left side to the right side defines a thickness, and wherein the simulated football helmet comprises a crest and a base wherein a distance from the crest to the base defines a height; a thickness-to-height ratio that decreases from the crest to the base yielding a center of gravity of the device is located at a point greater than half of the distance from a highest point of the crest to a lowest point of the base, wherein the thickness-to-height ratio decreases from between 0.2 and 0.3 inclusive at the crest to between 0.4 and 0.5 inclusive at the base; one or more display surfaces for displaying advertising information and/or graphics, the one or more display surfaces being disposed on one or more of the left side or the right side; the base of the device comprising a stand adapted to stabilize the device in an upright orientation on an arbitrary flat surface; and a vessel disposed in the space between the left side, the right side, and the crest, the device being adapted to retain the vessel therein, and the vessel including a port in fluid communication with an interior of the vessel and further including structure for sealing the port, the structure being selected from one or more of a cap, a hand pump, or a bung.

Embodiments may relate to a marketing display device, comprising a simulated football helmet comprising a left side and a right side, wherein a distance from the left side to the right side defines a thickness, and wherein the simulated football helmet comprises a crest and a base wherein a distance from the crest to the base defines a height; a thickness-to- height ratio that decreases from the crest to the base yielding a center of gravity of the device is located at a point greater than half of the distance from a highest point of the crest to a lowest point of the base, wherein the thickness-to-height ratio decreases from between 0.2 and 0.3 inclusive at the crest to between 0.4 and 0.5 inclusive at the base; one or more display surfaces for displaying advertising information and/or graphics, the one or more display surfaces being disposed on one or more of the left side, the right side, or the crest, wherein the one or more display surfaces comprise a material selected from an adhesive release material, a dry erase substrate, a chalk slate, or a static decal substrate; the base of the device comprising a stand adapted to stabilize the device in an upright orientation on an arbitrary flat surface; and a vessel disposed in the space between the left side, the right side, and the crest, the device being adapted to retain the vessel therein, and the vessel including a port in fluid communication with an interior of the vessel and further including structure for sealing the port, the structure being selected from one or more of a cap, a hand pump, or a bung.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a is a right side perspective view of an embodiment;

FIG. 2 is a front view of an embodiment;

FIG. 3 is a rear view of an embodiment;

FIG. 4 is a left side view of an embodiment;

FIG. 5 is a top view of an embodiment;

FIG. 6 is a bottom view of an embodiment;

FIG. 7 is a perspective view of a canteen embodiment;

FIG. 8 is a perspective view of a hand pump embodiment;

FIG. 9 is a perspective view of a coin bank embodiment;

FIG. 10 is a perspective view of a table top menu display embodiment; and

FIG. 11 is a perspective view of an alternative table top menu display embodiment.

### IV. DETAILED DESCRIPTION OF THE INVENTION

Embodiments of the invention may include an advertising display device in the general shape and form of a highly stylized simulated football helmet. Although the embodiments described herein focus on football helmets, other helmets or hats are also intended to be within the scope of the invention. As will be apparent from the description and figures herein, when viewed fore to aft embodiments appear compressed in the lateral direction which would tend to make such a device top-heavy; however, embodiments may be stabilized by tapering the device so as to shift its center of mass downward resulting in a device less prone to tip over. Embodiments may include one or more display surfaces suitable for receiving marketing, advertising, and/or promotional materials for display. Optionally, devices according to some embodiments of the invention may also include structure for containing and dispensing liquids, or for collecting objects such as coins for storage.

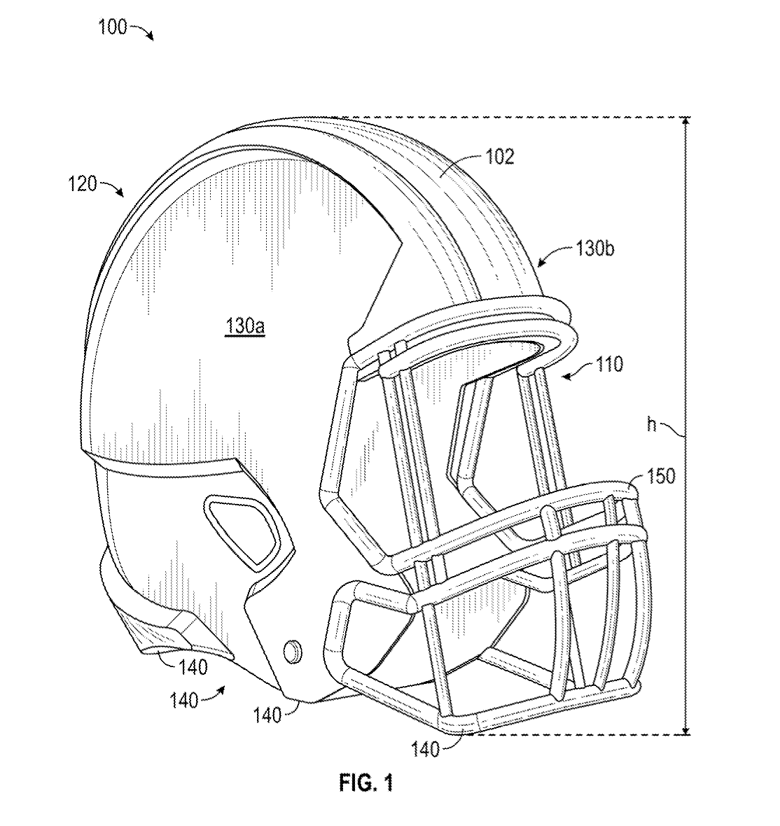

Referring now to the drawings wherein the showings are for purposes of illustrating embodiments of the invention only and not for purposes of limiting the same, FIG. 1 is a right side perspective view of an embodiment 100. The fore region 110 corresponds to the front of a football helmet where a simulated facemask 150 is located. The simulated facemask 150 may optionally serve to further stabilize the device against tip-over. The aft region 120 corresponds to the rear of a football helmet. The embodiment 100 includes a crest 102 which extends from fore 110 to aft 120 along a generally curved path as shown. Accordingly, the crest 102 forms a portion of the device's 100 profile, which when viewed side-on effectively simulates the side-silhouette profile of a football helmet.

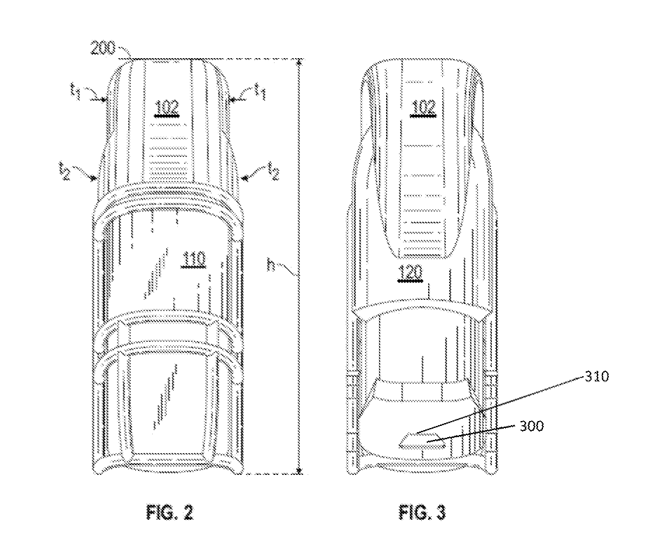

With continuing reference to FIG. 1, the device 100 also includes a base 140 located in a bottom region of the device 100. The base is defined by one or more elements of the device that are adapted to support the device 100 in an upright orientation when placed in contact with an arbitrary flat surface. The embodiment 100 shown in FIG. 1 includes several regions labeled with reference character 140 which are collectively adapted to function as a base. Since the illustrated embodiment 100 is symmetrical, it would be understood that similar regions 140 exist on the opposing side of the device which is out of view in FIG. 1. Line h in FIGS. 1 and 2 illustrates a height of the device 100 as measured from the lowest point of the base 140 to the highest point of the crest 102.

FIG. 2 shows the embodiment 100 in font-view with the fore region 110 of the device being visible. From this perspective one can see that the device 100 is tapered from the top of its crest 102 to its base 140. In this particular embodiment the tapering is stepped having two separate thicknesses t₁ and t₂ where t₁ is the thinnest and t₂ is thickest. The effect of tapering the device is to shift the device's center of mass downward thus making it more stable and less prone to tipping over. In one embodiment a device's thickness to height ratio (tₙ/h) varies from about 0.2 to 0.5. For instance, in the stepped configuration shown in FIG. 2, the thickness-to-height ratio at t₁ may be between 0.2 and 0.3 inclusive, while the ratio at t₂ may be from 0.3 to 0.6 inclusive. In this context, the term inclusive is used to indicate that a range may include its endpoints and all values therebetween. One skilled in the art will appreciate that embodiments may include more than two steps or may include no steps at all. Furthermore, the thickness to height ratio may vary continuously, discontinuously, and/or linearly from crest to base.

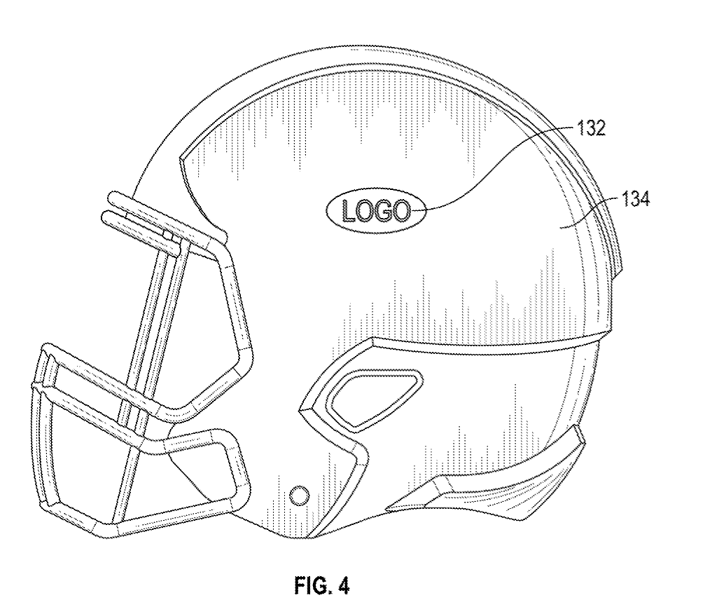

Also shown in FIG. 2 is that the crest 102 is generally flat when viewed fore-to-aft as shown by line 200. While the illustrated embodiment may not be perfectly flat across the entire thickness, and includes rounded edges, as used herein this is considered generally flat. FIG. 3 is a rear view of an aft region 120 of the embodiment 100. The flat portion of the crest 102 may be suitable as an additional display surface. FIG. 3 also shows an integrated bottle opener 300 in the lower rear of the device, including a ridge 310 for engaging and removing a standard bottle cap from, for instance, a beverage container.

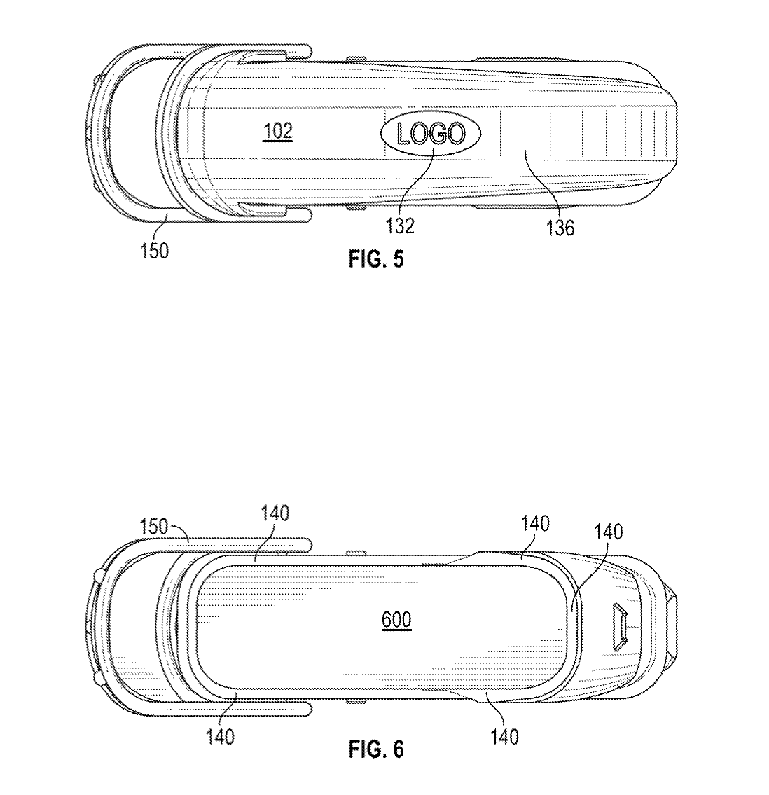

FIG. 4 illustrates a left side view of the embodiment 100 bearing a logo 132 on a display surface 134. The display surface 134 in this embodiment includes the entire side surface of the simulated helmet device 100 where a logo or other marketing matter may be displayed. The device 100 being symmetrical, a similar display surface 134 is disposed on the right side of the device 100. FIG. 5 shows a top view wherein a third display surface 136 is visible and comprises the generally flat region of the crest 102. Although three display surfaces 134, 136 are specifically pointed out, it is contemplated that any visible surface may be used as a display surface for marketing, advertising, or other promotional materials.

As used herein the terms marketing materials, advertising materials, and promotional materials used alone or in combination comprise logos including but not limited to logos of sports teams, trademarks of advertisers, paid advertisements, bar or restaurant menus, team schedules, and other graphical and/or textual matter that is amenable to printed media. In one embodiment, the display surface(s) may incorporate a bar or restaurant menu wherein the device is used as sign holder and/or menu holder.

Matter displayed on a display surface 134 may be directly printed on the device, or may comprise a decal that may be held in place using a static electric charge or a pressure-sensitive adhesive, or any other suitable means for mounting printed matter to the display surface 134. Furthermore, in embodiments where the display surface 134 is adapted to be directly printed upon, the display surface 134 may be specialized through appropriate material selection and surface preparation to receive permanent inks, dry erase inks, chalks, and/or similar materials. Similarly, the display surface 134 may comprise a material selected for its pressure sensitive adhesive release properties, or for its ability to hold a static charge sufficient to reversibly attach a static decal and thus function as a static decal substrate. It will be appreciated by the skilled artisan that proper material selection will depend on the specific nature of the corresponding adhesive and/or static decal.

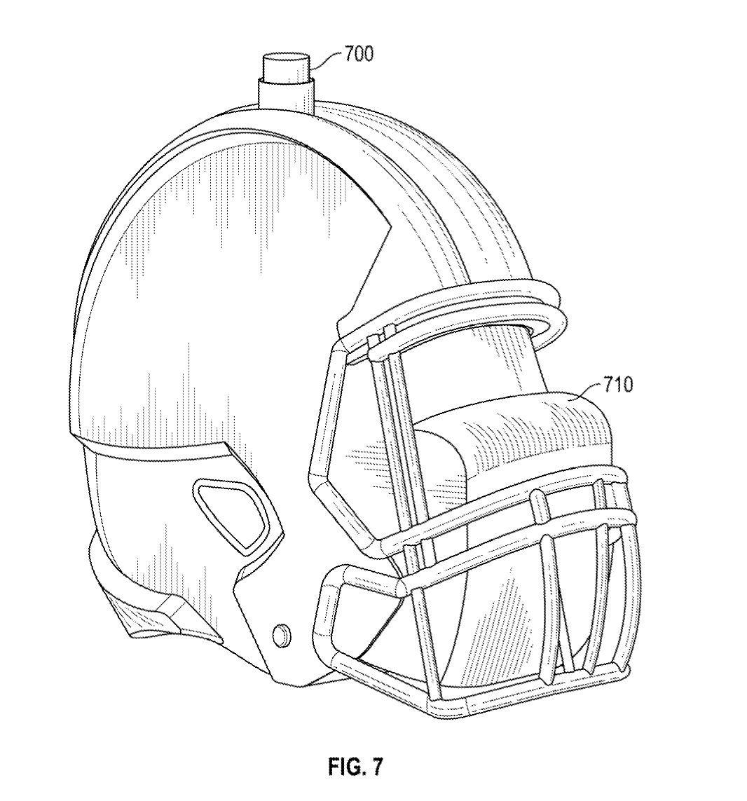

FIG. 6 is a bottom view of an embodiment showing the base 140 and simulated facemask 150. Also visible is a void space 600 corresponding to the volume that a head would occupy in a real helmet; however, in some of the various embodiments this void space 600 may be left void or may be occupied by a bottle or other vessel, the purpose of which will be apparent in the following embodiments.

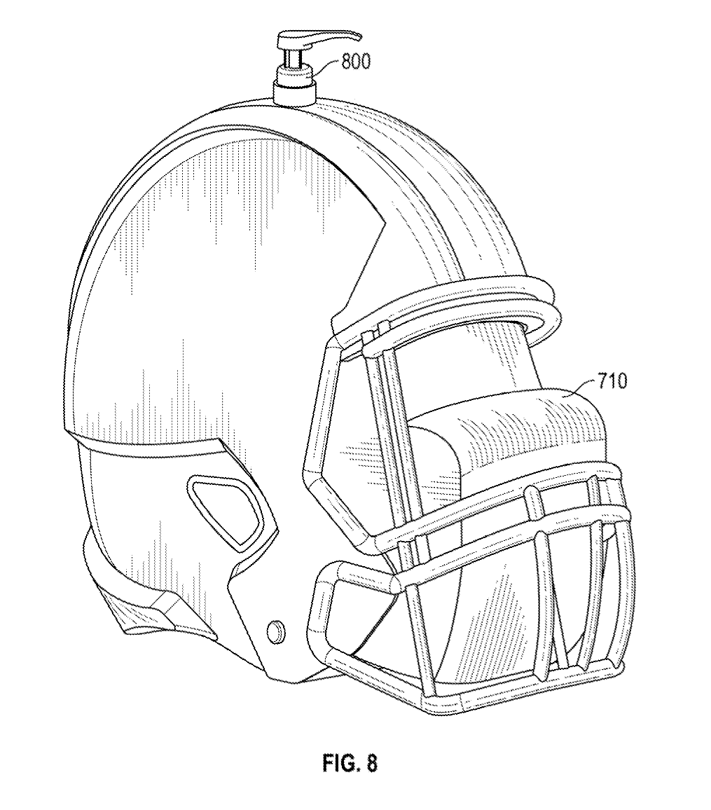

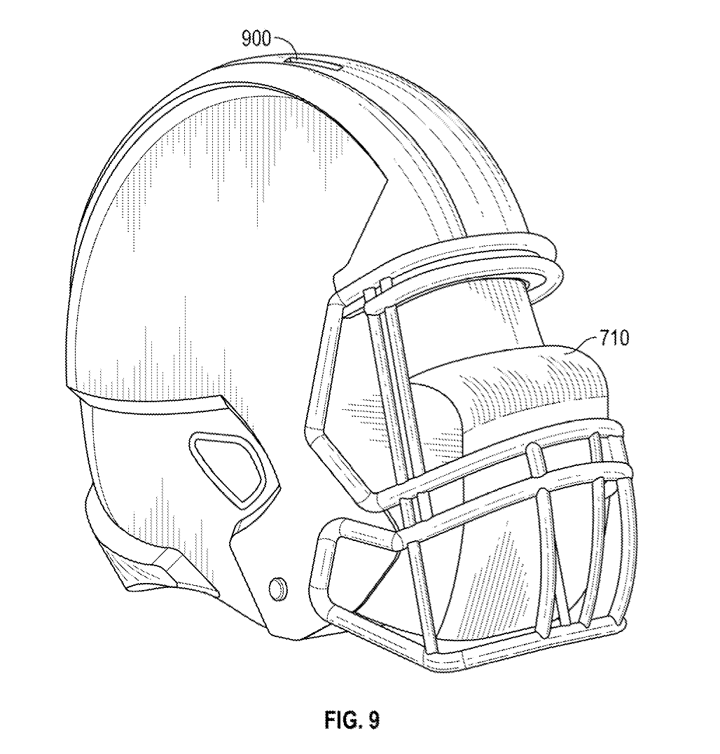

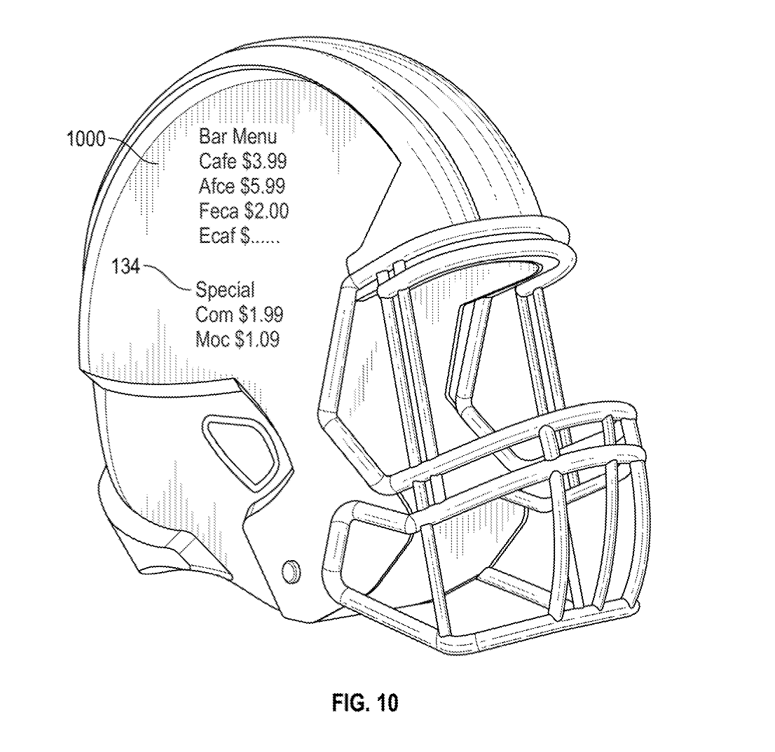

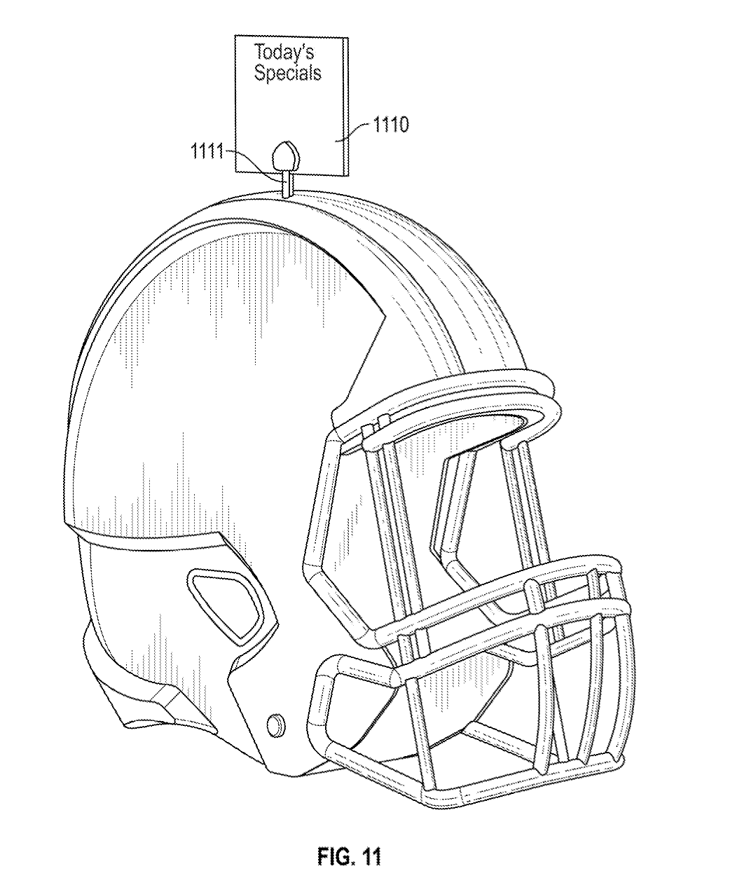

FIGS. 7 through 11 illustrate various purpose-built embodiments each of which adds certain elements. For instance, FIG. 7 comprises a canteen incorporating a cap 700 and a bottle 710. The cap 700 may function to seal a port in fluid communication with the interior of the bottle 710 and thereby prevent spillage of liquids contained therein. The bottle 710 may retained within the simulated helmet by structuring the bottle 710 and helmet to mate in a press-fit relation. Alternatively, the bottle 710 may be bonded to the helmet. FIG. 8 illustrates an embodiment incorporating a bottle 710 and a hand pump 800. The hand pump 800 may thus be used to dispense liquids contained within the bottle 710. FIG. 9 illustrates a coin bank embodiment wherein the bottle 710 receives objects through a slot 900 formed into the crest 102 of the helmet. FIG. 10 illustrates an embodiment comprising signage wherein one of the display surfaces 134 includes a menu which may be displayed on a bar or restaurant table top. FIG. 11 illustrates another menu embodiment, but further includes a stand 1111 for holding a menu 1110.

It will be apparent to those skilled in the art that the above methods and apparatuses may be changed or modified without departing from the general scope of the invention. The invention is intended to include all such modifications and alterations insofar as they come within the scope of the appended claims or the equivalents thereof

Having thus described the invention, it is now claimed:

I/we claim:

1. A marketing display device, comprising
a simulated helmet comprising a left side and a right side, wherein a distance from the left side to the right side defines a thickness, and wherein the simulated football helmet comprises a crest and a base wherein a distance from the crest to the base defines a height;
a thickness-to-height ratio that decreases from the crest to the base yielding a center of gravity of the device is located at a point greater than half of the distance from a highest point of the crest to a lowest point of the base;
one or more display surfaces for displaying advertising information and/or graphics, the one or more display surfaces being disposed on one or more of the left side or the right side; and
the base of the device comprising a stand adapted to stabilize the device in an upright orientation on an arbitrary flat surface.

2. The device of claim 1, wherein the crest extends from a fore region of the device to an aft region of the device along a generally curved path tracing out a portion of a profile of the simulated football helmet.

3. The device of claim 2, wherein the crest extends in a lateral direction from the left side of the device to the right side of the device tracing out a generally flat path from the left side to the right side.

4. The device of claim 3, wherein the thickness-to-height ratio decreases from between 0.2 and 0.3 inclusive at the crest to between 0.4 and 0.5 inclusive at the base.

5. The device of claim 3, wherein the crest defines a display surface.

6. The device of claim 3, further comprising a vessel disposed in the space between the left side, the right side, and the crest, the device being adapted to retain the vessel therein.

7. The device of claim 6, further comprising a port in fluid communication with an interior of the vessel.

8. The device of claim 7, further comprising structure for sealing the port, the structure being selected from one or more of a cap, a hand pump, or a bung.

9. The device of claim 7, wherein the port defines a slot adapted to receive coins.

10. The device of claim 1, further comprising a simulated facemask.

11. The device of claim 1, wherein the one or more display surfaces comprise a material selected from an adhesive release material, a dry erase substrate, a chalk slate, or a static decal substrate.

12. A marketing display device, comprising
a simulated football helmet comprising a left side and a right side, wherein a distance from the left side to the right side defines a thickness, and wherein the simulated football helmet comprises a crest and a base wherein a distance from the crest to the base defines a height;
a thickness-to-height ratio that decreases from the crest to the base yielding a center of gravity of the device is located at a point greater than half of the distance from a highest point of the crest to a lowest point of the base, wherein the thickness-to-height ratio decreases from between 0.2 and 0.3 inclusive at the crest to between 0.4 and 0.5 inclusive at the base;
one or more display surfaces for displaying advertising information and/or graphics, the one or more display surfaces being disposed on one or more of the left side or the right side;
the base of the device comprising a stand adapted to stabilize the device in an upright orientation on an arbitrary flat surface; and
a vessel disposed in the space between the left side, the right side, and the crest, the device being adapted to retain the vessel therein, and the vessel including a port in fluid communication with an interior of the vessel and further including structure for sealing the port, the structure being selected from one or more of a cap, a hand pump, or a bung.

13. The device of claim 12, wherein the crest extends from a fore region of the device to an aft region of the device along a generally curved path tracing out a portion of a profile of the simulated football helmet.

14. The device of claim 12, wherein the crest extends in a lateral direction from the left side of the device to the right side of the device tracing out a generally flat path from the left side to the right side.

15. The device of claim 12, wherein the one or more display surfaces comprise a material selected from an adhesive release material, a dry erase substrate, a chalk slate, or a static decal substrate.

16. The device of claim 12, wherein the crest defines a display surface.

17. A marketing display device, comprising
a simulated football helmet comprising a left side and a right side, wherein a distance from the left side to the right side defines a thickness, and wherein the simulated football helmet comprises a crest and a base wherein a distance from the crest to the base defines a height;
a thickness-to-height ratio that decreases from the crest to the base yielding a center of gravity of the device is located at a point greater than half of the distance from a highest point of the crest to a lowest point of the base, wherein the thickness-to-height ratio decreases from between 0.2 and 0.3 inclusive at the crest to between 0.4 and 0.5 inclusive at the base;
one or more display surfaces for displaying advertising information and/or graphics, the one or more display surfaces being disposed on one or more of the left side, the right side, or the crest, wherein the one or more display surfaces comprise a material selected from an adhesive release material, a dry erase substrate, a chalk slate, or a static decal substrate;
the base of the device comprising a stand adapted to stabilize the device in an upright orientation on an arbitrary flat surface; and
a vessel disposed in the space between the left side, the right side, and the crest, the device being adapted to retain the vessel therein, and the vessel including a port in fluid communication with an interior of the vessel and further including structure for sealing the port, the structure being selected from one or more of a cap, a hand pump, or a bung.

18. The device of claim 17, wherein the crest extends in a lateral direction from the left side of the device to the right side of the device tracing out a generally flat path from the left side to the right side.

19. The device of claim 17, further comprising a bottle opener located at a lower rear portion of the device.
